(19) United States
(12) Patent Application Publication
(10) Pub. No.: US 2007/0116362 A1
(43) Pub. Date: May 24, 2007

(54) Method and device for the structural analysis of a document

(75) Inventor: Ralph Tiede, Hamburg (DE)

Correspondence Address: Lipsitz & McAllister, LLC, 755 MAIN STREET, MONROE, CT, 06468, US

(73) Assignee: CCS Content Conversion Specialists GmbH, Hamburg (DE)

(21) Appl. No.: 11/607,798

(22) Filed: Nov. 30, 2006

Related U.S. Application Data
(63) Continuation of application No. PCT/EP05/05913, filed on Jun. 2, 2005.

(30) Foreign Application Priority Data
Jun. 2, 2004 (EP) 04 012 995.9

(51) Int. Cl. G06K 9/00; G06K 9/34; G06F 17/00

(52) U.S. Cl. 382/181; 382/173; 715/513

(57) ABSTRACT

A method for the structural analysis of a document is proposed, wherein a template is broken down into elementary structural units and, based upon these elementary structural units, generic objects are produced to which one or more properties are assigned, whereby a structure representing the template is produced in an electronic format by means of the generic objects.

This application is a continuation of international application number PCT/EP2005/005913 filed on Jun. 2, 2005.

The present disclosure relates to the subject matter disclosed in international application number PCT/EP2005/005913 of Jun. 2, 2005 and European application number 04 012 995.9 of Jun. 2, 2004, which are incorporated herein by reference in their entirety and for all purposes.

### BACKGROUND OF THE INVENTION

The invention relates to a method for the structural analysis of a document.

Furthermore, the invention relates to a device for the automatic structural analysis of documents.

In order to enable documents to be stored electronically, electronic data must be produced from a template (the original or a portion of it) insofar as such electronic data is not already available. In the case of printed documents, the template must be scanned for this purpose. The provision of a large amount of memory is necessary for the storage of the data resulting from the scanning process. Furthermore, direct evaluation of this data is not possible. Consequently, it is desirable for only the relevant data elements of the template, such as the text for example, to be stored whereby it is also then possible to effect an electronic evaluation. However, the text must be filtered out to a certain extent from the scanned data; a structural analysis of the document then has to be carried out.

Methods for the structural analysis of the layout, especially of the pages of a newspaper, are known and the printed pages of the newspaper are storable in an electronic format by means thereof. For example, a method for the processing of an image of a template is known from EP 0 629 078, wherein digital pixel information representative of the image is obtained and then automatic segmentation of this digital pixel information into layout elements is effected. The image is presented to an operator for the purposes of selecting one or more layout elements which were found in the segmenting step. Furthermore, at least one transmission operation is presented for selection by an operator in order to enable a layout element to be transmitted to another position. The digital pixel information which represents a selected layout element is then processed for agreement with a selected transmission operation.

From EP 0 753 833 B1, there is known a method for the automatic processing of an image of a document which contains several articles, perhaps a page of a newspaper, wherein items of graphical data are segmented into elementary components of an image. These objects are then typified as one of several possible object types and mutual positional relationships between the objects are extracted from the graphical data. The objects of the image are subsequently classified into an article, whereby a given set of rules is applied to these objects, said rules setting the mutual appertaining relationship between the types and the mutual positional relationships thereof.

### SUMMARY OF THE INVENTION

In accordance with the invention, a method and a device for the structural analysis of a document is provided by means of which or with the aid of which a structural analysis of a document can be carried out in a flexible manner.

In accordance with the invention, a template is broken down into elementary structural units and, based upon these elementary structural units, generic objects are produced to which one or more properties are assigned, whereby a structure representing the template is produced in an electronic format by means of the generic objects.

Due to the fact that provision is made for generic objects which are not “rigidly” defined but rather, to which one or more properties can be assigned and in particular can be arbitrarily assigned, there is made available a system which can be adapted with little effort to a multitude of templates whereby in principle, there is no restriction in regard to the template. This thus enables a dynamic portrayal of arbitrary structures and layouts to be made. In particular, the elements and objects (and in particular the generic objects) underlying the analysis are produced and adapted dynamically during the run time. The template may be present in a printed format for example, or already be in an electronic format.

If a template contains certain special features, then the system can be adapted in a flexible manner by appropriate definition of the generic objects in order to enable a structural analysis of the corresponding document to be effected.

The document is firstly broken down into elementary structural units which constitute the starting point for the further proceedings. The elementary structural units are the smallest units, i.e. the “atoms”, starting from which the structural analysis is effected. The elementary structural units can be different in dependence on the type of document. In the case of a printed document, the elementary structural units could be pixel data, whereas in the case of an electronic text document the elementary structural units can be whole letters or whole words. Outgoing from these elementary structural units, the generic objects are produced and, based thereupon, a structure representing the template is then in turn produced in an electronic format. Due to the definition of the generic objects and especially from the allocation of the properties, there is then made available a flexible system which is adaptable to any sort of template in order to enable a structural analysis of any sort of template to be carried out in correspondence therewith.

In accordance with the invention, an analysis of the layout of the pages of a newspaper can be carried out for example. Books can also be analysed. Furthermore, structured documents such as patent specifications, contracts or tables can be analysed and turned into an electronic format. It is also possible to analyse documents which are already present in an electronic format such as web pages for example, and to convert them into a structure which requires less storage space than the original page and thereby makes it accessible for an analysis of its contents for example. Furthermore, directories, catalogues, telephone directories and the like can be turned into an electronic format by means of the method in accordance with the invention.

The fundamental starting point for the structural analysis of a document is the optical structure of the documentary material. On the basis of this optical structure, textual contexts and pictorial contexts in particular can then be detected in order to produce in turn the representative structure.

In addition or alternatively, a content analysis which is in turn accessible via the generic objects can also be effected. The content analysis involves a search for given keywords for example. Layout analysis and content analysis can be linked in accordance with the invention.

It is expedient if one or more properties are assigned to the elementary structural units; in particular, positional values are assigned to the elementary structural units.

The properties which are assigned to the generic objects and/or the elementary structural units relate, in particular, to the order and/or the meaning and/or the hierarchy in the optical appearance of the template. The contextual relationships between elementary structural units can then be determined so as in turn to produce a structure representing the template in an electronic format but one however, which requires a smaller amount of storage space than the storage spaced needed for the elementary structural unit data in its entirety.

It is especially particularly advantageous, if the property or properties which are assigned to a generic object are definable.

A corresponding system can thereby be adapted in a simple manner to a certain type of template i.e. the system is not limited to one or just a few types of template. The modification can be carried out in a simple manner without the entire system having to be newly programmed. Since the adaptation takes place at the level of the generic objects upon the basis of which the structure representing the template is produced, a high degree of flexibility for the system is achieved.

In particular thereby, provision may be made for a logical functionality that characterizes the function of the object in the document to be assigned to a generic object. For example, the object can be a text object which contains text elements. Then for example, the assigned function is the heading, the introduction, a sub title or the like, in particular, with regard to an article in the document forming the documentary material. The function can in turn be defined as a property of the generic object.

It is expedient, if the logical functionality is determined by the font size of text elements and the position of the text elements which are comprised by the generic object, and in particular, if it is determined by the font size and the position alone. Indeed, for these text elements, the font size and the position are the essential criteria in regard to the function of the text element in the complete text. Graphical “ancillary details” such as lines and non-textual graphics can be regarded as objects of font size “zero”. Then, on the basis of the generic objects and taking into consideration the logical functionality of the objects, the structure of the document forming the template can be portrayed hierarchically.

It is expedient if the number of assigned properties is definable (i.e. the number of assigned properties is not unchangeably fixed) so as to attain a high degree of flexibility.

For the same reason, it is expedient if the type of an assigned property is definable.

In this connection, it is also particularly expedient if arbitrary additional properties can then be assigned to a generic object or an elementary structural unit. This then enables the system to be adapted in a simple manner to the most varied of template types without a fundamental reprogramming thereof being necessary.

A property assigned to a generic object comprises a type component for the type of property and a value component for the value of the property. In this way, operations can then be carried out on the generic objects in order to classify the generic objects and/or produce new generic objects for example.

It is then expedient if operations are carried out on or with the elementary structural units and/or generic objects so that, based upon the elementary structural units, a structure representing the templates which is then present in an electronic format can thereby be obtained.

One or more of the operations selection, attribution, grouping, dividing, sorting, hierarchical formation or contour determination is carried out on or with the elementary structural units and/or the generic objects in order to produce the representative structure.

It is especially particularly advantageous, if, on the basis of the elementary structural units, the structure representing the documentary material is produced hierarchically. This is then a “Bottom up” process, wherein the template is broken down into the smallest elementary structural units in dependence on the type of template and outgoing therefrom, the structure representing the template is produced hierarchically. During this process for the portrayal of the hierarchy, unnecessary elements such as graphical elements in textual documentary materials for example, are eliminated. The structure produced in an electronic format can then be optimised in regard to the requisite storage space. In particular, the documentary elements that are not necessary for an evaluation of the document are eliminated.

Provision is made for hierarchically higher ranking objects to be produced from hierarchically lower ranking objects by one or more of the operations selection, attribution, grouping, dividing, sorting, hierarchical formation or contour determination.

It is especially particularly advantageous, if operations concerning the elementary structural units and/or the generic objects are carried out by means of sub steps defined by a script. A high degree of flexibility for the system is thereby obtained since the script is expandable in a simple manner in order to enable new types of templates to be encompassed in this way for example.

The script is stored in one or more script data bases. It is thereby ensured that the script is expandable in a simple manner so that in turn, new operations in regard to the elementary structural units and/or the generic objects can be created in a simple manner without needing to reprogram the system.

Provision may be made for a script to be subdivided into classes. This thus caters for additional flexibility of the system.

Provision may also be made for parameter dependent scripts, whereby the execution thereof is then dependent on a parameter. This too caters for a high degree of flexibility.

Provision may be made for a generic object of the type “collection” which can gather up other objects. Such a generic object is, for example, a sentence object which can gather up the word components of the sentence.

Furthermore, provision may be made for a generic object of the type “container” which contains objects of the same category. For example, such an object can contain the paragraphs of an article.

Provision may be made for a generic object of the type “memory” which receives data and makes data available.

A generic object of the type “document” which specifies an item of documentary material can also be provided.

Provision may also be made for a generic object of the type “page” which characterises a page of the template.

A generic object of the type “picture segment” which is concerned with coherent sequences of pixels within an illustrated page can be defined.

It is possible for the template to be a printed template. Electronic items of data relating to the template that will be used for subsequent processing are then produced, in particular, by a scanning process. In this case then, the elementary structural units upon the basis of which further processing is carried out are pixel data.

It is also possible to process templates in an electronic format such as web pages by the method in accordance with the invention. Provision is then made in accordance with the invention for the data relating to the template to be produced by a virtual printer driver. The individual elements of the template in the case of an electronic document are also arranged in accordance with optical criteria. A printer driver produces a representation of a template in accordance with optical criteria. Due to the “virtual printer driver” in accordance with the invention, items of data relating to the template which were produced based on optical criteria (as in the case of a printing process) are made available to the system in an electronic format. A conversion of the templates into another format is not necessary, but rather, just “virtual print data” is produced whose essential feature is the optical arrangement of the corresponding elements in the document forming the template.

The elementary structural units of data relating to the template that are produced by means of a virtual printer driver lie at least partly above a pixel level since the optical information in regard at least to textual elements is at a higher level than the pixel level. For example, whole letters can be recognized as such, and also words and even sentences can be recognized as such. These corresponding elements are then the elementary structural units upon the basis of which the further processing action takes place. In addition, pixel data can be produced in order to enable the data to be more easily displayed for example. However, in regard to the data relating to the template that is produced by the virtual printer driver, then, at least for the textual elements, one can climb to a higher level in the hierarchy for the subsequent processing action than that to which the pixel level corresponds. The processing can thus be carried out more rapidly since processing steps can be saved.

It is expedient if a contour determination is carried out for an object. Objects can thereby be classified into given contours. In particular, the given contours that are selected are simple, such as simple geometrical shapes for example. The storage requirements can also be minimized in this way for example. In particular, the optimum given contour for an object is determined.

It is possible to place a contour in the form of a rectangle around the object. It is also possible to place a contour in the form of a rectangular block consisting of a plurality of rectangles around the object.

Furthermore, it is possible to place a contour in the form of a convex envelope around the object.

A rolling contour can also be placed around the object.

It is expedient, after a process of scanning an item of a template, if black and white images are converted into grey images. It is thereby possible to recognize rastered backgrounds as being backgrounds and separating them.

It is also expedient for the purposes of determining the foreground and the background (in a black/white image) if grey images with the same or a similar grey tonal value are compared. In such a way for example, cells of strongly deviating brightness can be rated as foreground.

In accordance with the invention, a device for the automatic structural analysis of documents is provided, with a breaking down device for breaking down a template into elementary structural units, and with a structure producing device for producing a structure representing the template in an electronic format, wherein the structure producing device comprises a device for producing generic objects to which one or more properties are or will be assigned, and for carrying out operations on or with the generic objects and/or the elementary structural units.

This device for the automatic structural analysis of documents is suitable, in particular, for carrying out the method in accordance with the invention.

It exhibits the advantages that have already been described in connection with the method in accordance with the invention.

Likewise, further advantageous embodiments have already been described in connection with the method in accordance with the invention.

Furthermore, the invention relates to a computer program product including at least one computer-readable medium and a computer program that is stored on the at least one computer-readable medium and comprises program code means which are suitable for implementing the method in accordance with the invention when running the computer program on one or more computers.

Furthermore, the invention relates to a computer program comprising program code means which are suitable for implementing the method in accordance with the invention when running the computer program on one or more computers.

The following description of preferred embodiments serves, in conjunction with the drawing, for a more detailed explanation of the invention.

### BRIEF DESCRIPTION OF THE DRAWINGS

FIG. 1 shows a schematic block diagram of a device in accordance with the invention for the automatic structural analysis of documents;

FIG. 2 shows a block diagram of an exemplary embodiment of a device in accordance with the invention;

FIG. 3 schematically shows the steps of the grey conversion process, the separation, the determination of rastered texts and the determination of grey backgrounds in the case of a page of a newspaper serving as the documentary material;

FIG. 4 schematically shows the construction of a generic object and examples of generic objects;

FIG. 5 shows exemplary flow charts for the structural analysis of image files and of electronic documents and

FIGS. 6(a) to (d) show examples for the contour determination of objects.

### DETAILED DESCRIPTION OF THE INVENTION

The device in accordance with the invention for the automatic structural analysis of documents and the method in accordance with the invention for the structural analysis of a document serves, in particular, for analysing the layout of documents. For example, the pages of a newspaper can be analysed thereby in order to recognize articles in particular and then make these electronically accessible. Books too can be analysed; these can be organised, in particular, into chapters and sub chapters. Furthermore, meta data such as a preface, the impression, the author, the publisher, a copyright note and the like can be detected. Structured documents such as patent specifications, contracts or tables can also be analysed. It is also possible to analyse documents which are present in an electronic format such as web pages for example, whereby in particular, a distinction between the contents and banners can be made. Furthermore, directories, catalogues, telephone directories and similar documents can be read and turned into an electronic format. A directory is a book-like table of contents for an archive.

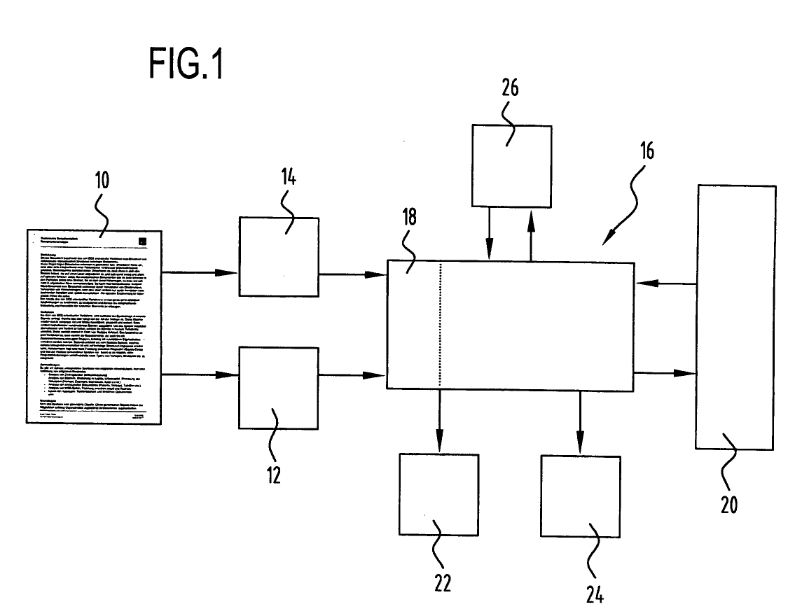

A document 10 which is to be analysed may be available in a printed form or in an electronic form. In the case of a printed template, this is scanned by a scanner 12 (FIG. 1). In the case of an electronic template, this is controlled by a virtual printer driver 14, i.e. it is printed virtually. Due to the virtual printer driver 14, the optical appearance of the template can be represented in a corresponding print image without the electronic structure of the document (the program structure), which can be format dependent and may be inhomogeneous, having to be analysed.

The data relating to the template that is supplied by the virtual printer driver 14 or the scanner 12 is fed to an analysing device 16. Hereby, this analysing device comprises a breaking down device 18 by means of which the template is adapted to be broken down into elementary structural units on the basis of the data relating to the template that has been made available by the virtual printer driver 14 or the scanner 12.

Furthermore, the analysing device 16 comprises a structure producing device 20 by means of which a structure representative of the template is producible in an electronic format on the basis of the elementary structural units.

The result of the analysis can be passed on to an output device such as a printer 22 or a storage device 24.

The analysing device 16 can comprise one or more user interfaces 26 via which the user can affect the analysing process. In particular, the user could also gain access to the structure producing device 20 via such a user interface 26.

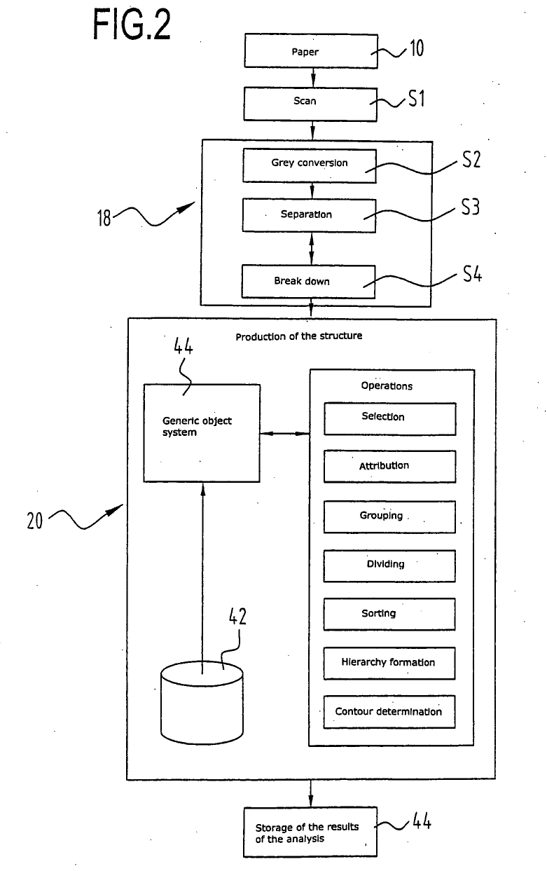

In the following, an exemplary embodiment of the method in accordance with the invention is described on the basis of the structural analysis of a printed document 10 (FIG. 2):

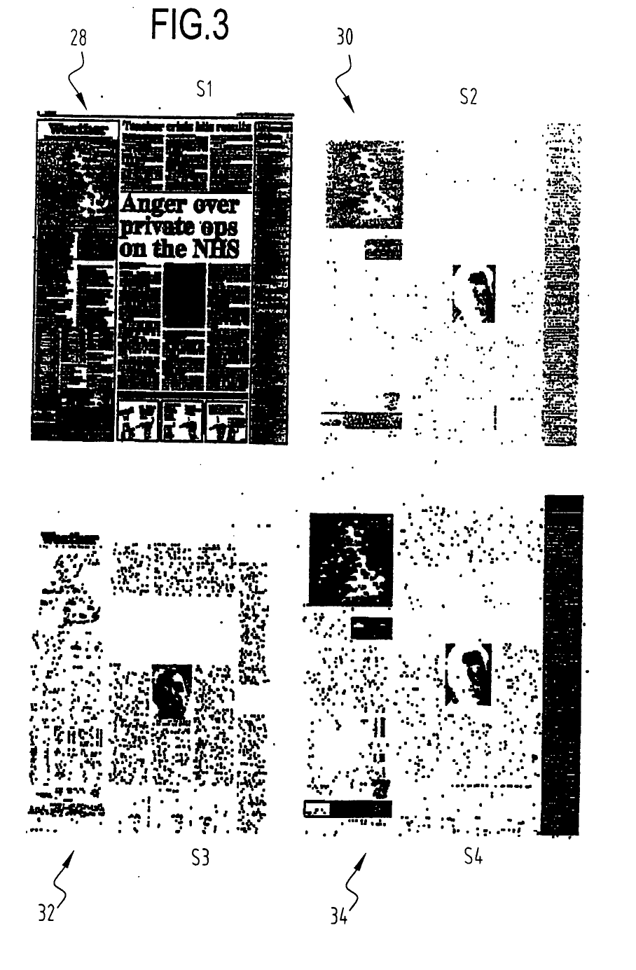

In a step S1, the template 10 (original document or part of it) is scanned by the scanner 12. In consequence, the original documentary material (template) is then present in the form of an electronic documentary material 28 incorporating items of data relating to the template (FIG. 3). The items of data relating to the template are pixel data, i.e. items of graphical data which are arranged in a certain order.

In a further step S2, black/white images are converted into grey images 30. It is thereby possible to detect rastered backgrounds as being in fact backgrounds and to separate them out. For example, in the course of the grey conversion process, image files are broken down into cells having a size of 4 by 4 pixels. For each of these cells, a grey tonal value is then determined from the number of black pixels contained therein and the appropriate grey tonal value is obtained therefrom. Provision could also be made for the determined grey tonal values to be averaged with those of the neighbouring cells in order to produce a smoothing effect; tolerances arising from the scanning process are thereby balanced out.

In a further step S3, areas having a similar grey tonal value are then determined from the established grey images. A background and a foreground can be determined by examining these areas, in particular, in regards to the size, the form and the degree of filling. Cells that have a strongly deviating level of brightness are rated as foreground. In this way, there is produced a virtual image 32 in which rastered texts are detected. Furthermore, a virtual image 34 is produced in which grey backgrounds are detected.

In a further step S4, a process of breaking the data down into elementary structural units is then effected, in particular, based upon the virtual images 28, 30, 32, 34, whereby the sequences of coherent black pixels are determined as segments on a line by line basis. The elementary structural units here are, in particular, pixels.

On the basis of these elementary structural units, a structural analysis and hence recognition of a structure and recognition of the layout in the template 10 (based upon the documentary material 28 in an electronic format) is then carried out in the structure producing device 20. To this end, a structure is produced in an electronic format on the basis of the elementary structural units. This structure produced in such a manner portrays the optical structure of the template 10 and represents the result of the analysis of the document 10. Thereby, the production of the structure is based on optical criteria, i.e. on the structure of the document 10 such as is intended for a reader i.e. on the optical appearance of the document 10, and, as an alternative or in addition in dependence upon the application, also upon content criteria; these content criteria are determined by a content analysis process.

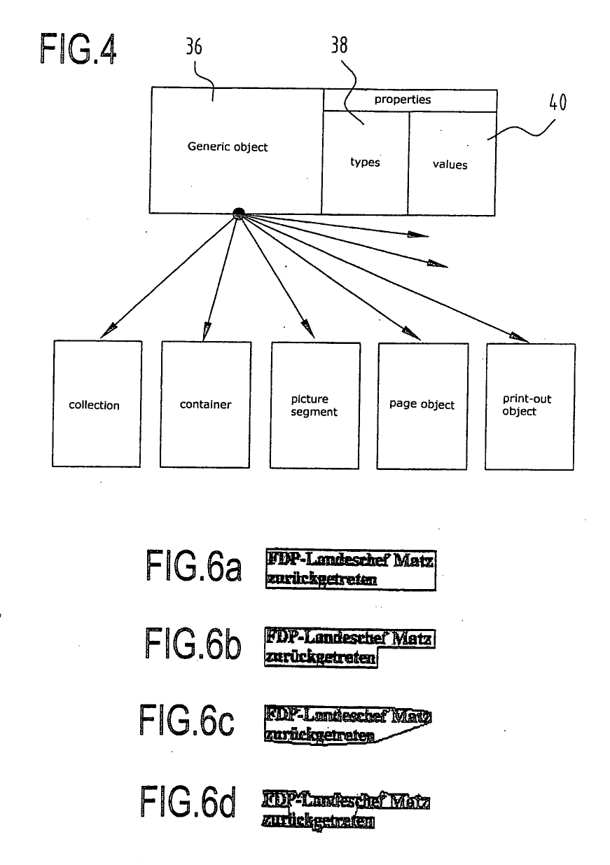

The elementary structural units are treated in the structure producing device 20 as objects 36 to which one or more properties are assigned (FIG. 4). Thereby, a property assignment process comprises a type component 38 for the type i.e. the name of the property and a value component 40 for the value of the property. Such properties for an elementary structural unit are, for example, the position in the documentary material 28 and/or the classification as a foreground or a background.

The value of a property can, for example, be a Boolean value, a number, a character string or a generic object.

On the basis of these objects, generic objects are in turn produced to which one or more properties are likewise assigned. In principle thereby, arbitrarily defined properties can be assigned to the generic objects 36 so as to form a flexible system in this manner.

Operations are then carried out on or with the generic objects 36 and the elementary structural units in order, on the basis of the elementary structural units, to produce a hierarchical structure in an electronic format which represents the optical appearance of the document 10, whereby as an alternative or in addition, an analysis of the contents can be provided.

Operations are carried out on or with the generic objects and the elementary structural units in sub steps which are defined in the form of a script. To this end, one or more script data bases 42 are provided. TCL is used as the script language for example.

A script itself in the script data base 22 is specially classified. The script can be parameter dependent so that, for example, the same script can be implemented with different parameters in the event of different applications of use or for different types of templates.

Due to the generic object system 44 that is implemented in the structure producing device 18 and by means of which the elementary structural units and the objects produced on the basis thereof can be provided on an arbitrary basis with additionally defined properties, the system can be designed in a very flexible manner and a plurality of different documentary materials can be analysed and the structures therein detected. The system is expandable in a flexible manner and can be adapted to the most diverse kinds of structures. A clear separation between program code and the script from the script data base 42 that is used for the analysis can be achieved so that new types of documentary materials, structures, applications and the like are also integrable without the need for modifications to the program.

If a document 10 that is to be analysed contains text, then, in the course of the process of producing the structure, generic objects are produced which comprise text elements. Provision may be made for a logical functionality that characterises the function of the text elements in the document to be assigned to such an object; for example, from a functional aspect, such a generic object can be a single letter or, at a higher hierarchical level, it could be a heading, an introduction to an article for example, a sub title and so on. The matters of crucial importance hereby are the font size of a text element and the position of the text element within the object. It is in fact so, that in many applications, it is just the font size and the position alone that are of importance. Lines and graphics can be characterised as text elements having a font size of “zero” for example.

The structure representing the template can then be built up in a hierarchical manner in that the template is developed electronically on the basis of the logical functionalities of the generic objects.

Operations such as selection, attribution, grouping, dividing, sorting, hierarchical formation or contour determination can be carried out on or with the elementary structural units and the further generic objects 36, this list not being exhaustive.

In the case of selection for example, individual objects are selected from a given number of objects. The selection is effected on the basis of differing conditions which in turn are determined by the properties of the objects in this number. In particular, provision could also be made for the objects themselves to have to exhibit certain properties and for these properties to have certain relationships with the properties of neighbouring objects.

In the case of attribution, one or more properties are assigned to one or more objects. Due to the generic object system 44 in accordance with the invention, attributes can thereby be assigned to an object in an arbitrary manner. One such property can be e.g. the type of an object in order to enable the objects to be classified. New attributes can also be produced dynamically.

In the case of grouping, objects that meet certain conditions, i.e. which exhibit certain properties are combined into groups. For example, points which are regularly spaced from one another can be combined as a dotted line.

In the case of division, objects are broken down into several separate objects. For example, if a line touches an image then the line must be separated from the image and stored separately as an object, i.e. the object consisting of the combination of an image and a line is broken down into a separate image object and a separate line object.

In the case of sorting, objects are sorted in accordance with their properties. For example, text blocks on a page are sorted in accordance with their font size so as to determine the hierarchical structures on the basis of the largest characters i.e. so as to enable, in particular, a distinction to be made between headings and the text itself. For the sorting process, different methods such as quicksort, bubblesort or else a hash process can be used.

The formation of a hierarchy is an essential operation for the hierarchical production of the structure in an electronic format. Hereby, objects are ranked lower than others, i.e. lower ranking and higher ranking objects are formed. Thus, outgoing from the elementary structural units (segments), hierarchically arranged letter objects are formed, then word objects are formed in turn from the letter objects, line objects are formed from the word objects and paragraph objects are formed from the line objects.

It can be important for the presentation of the result of the analysis for a contour determination to be effected, for example, of text blocks. In the case of the contour determination process, those objects that will be presented to the user as the smallest unit (such as text blocks for example) are used in their entirety as the basis for the computation of the respective contour. Methods for the determination of a contour are described hereinbelow.

Due to the generic object system 44, a plurality of objects and object types are definable, whereby the objects are characterised by content and properties. In principle hereby, objects and object types are freely definable. Important objects are objects of the “collection” type for example; such objects are able to collect up arbitrary other objects. Arbitrary objects can be grouped by means of objects of the “collection” type.

A generic object of the type “container” contains objects of the same respective category. Mechanisms such as hierarchy and heredity can be portrayed by such objects, i.e. a hierarchical structure in particular can be produced.

A memory object is an object which receives data and makes data available and in particular, only serves for the acquisition of data and the supply of data.

A document object is an object which specifies a complete document. Access to the meta data and also to the page of a document or the pages of a document if the document is multi-sided is enabled by a document object.

A page object is an object which refers to a page of a document, namely and in particular, to the image page of the document. It enables access to be made to the properties of the page e.g. the page size. Furthermore, it enables access to be made to graphical data and in particular to individual pixels.

An object of the type picture segment refers to coherent sequences of pixels within an illustrated page.

A printout object is an object which enables access to be made to the corresponding items of data for a template which was printed virtually by means of the “virtual printer driver”. Items of information such as the font, typeface, text (which determine the print image) etc. were extracted directly thereby and stored in the printout object.

On the basis of the elementary structural units (segments) into which the template was broken down, the structure of the template is represented hierarchically by means of the structure producing device 20. Properties are assigned to the elementary structural units for this purpose. Furthermore, generic objects are formed to which one or more properties are likewise assigned. Hereby, the assigned properties are determined, in particular, by the arrangement and/or the meaning and/or the hierarchy in the optical appearance of the template. The operations specified above are carried out once again on or with the elementary structural units and the generic objects.

The representation of the structure is effected both with consideration to optical criteria, i.e. by analysis of the layout of the template. In addition however, internal properties (content) of the template can also be used as a basis for the production of the structure.

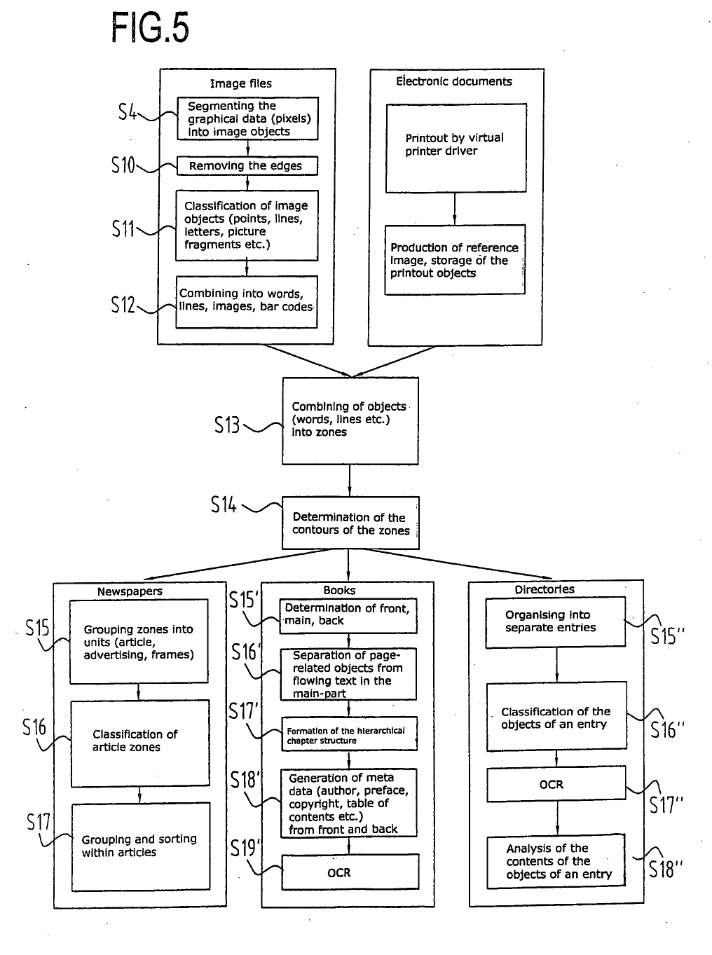

The flow diagram for a concrete implementation of the method is shown schematically in FIG. 5:

In the case of a template (image file) available in printed form, segmentation of the graphical data is carried out, in particular, in pixels after the scanning process. These elementary structural units that are formed in such a manner are assigned as properties, in particular, their position in the template.

In a further step S10, edges are removed in order to eliminate components of the template that are irrelevant for the structure.

A process of classifying image objects, for example, into points, lines, letters, picture fragments is then carried out in a step S11. Thereby, objects are formed which are classified accordingly. The objects are in turn sorted and brought together in a step S12, for example, into words, lines, images, bar code etc.

These objects are then combined hierarchically into higher ranking objects. For example, words or lines are combined into zones. In the case of the combining of words, such a zone is a text block. This combining process takes place in a step S13.

In a step S14, the contour of such a zone (such as a text block for example) is determined in order to simplify the portrayal.

The subsequent processing of the zone objects—with or without contour determination—can then be effected in dependence on the type of template. In the case of a newspaper serving as the template, the zones are grouped into higher ranking units such as articles, advertising or frames in a step S15 for example. The corresponding zones such as article zones for example are classified in a step S16. A process of grouping and sorting within articles is effected in a step S17.

In the case of books, a detection process in regard to front, main, back is carried out in a step S15′ in order to enable cover pages and the main part of the book to be determined.

In a step S16′, page-related objects for example are separated from the flowing text in the main part of the documentary material. A hierarchical chapter structure can then be formed in a step 517′. Meta data which comprises the title, the author, the publisher, the preface, a copyright note, a table of contents and the like for example is formed in a step S18′, this meta data being generated from the front and back objects.

A text recognition process (OCR) is carried out in a step 519′.

In the case of directories, catalogues and telephone directories, the layout thereof is organised into separate entries in a step S15″. The objects of an entry are classified in a step S16″. A text recognition process for each entry is carried out in a step S17″. An analysis of the content of the objects of an entry is carried out in a step S18″.

The final result of the analysis is stored in a memory 44 (FIG. 2). In particular thereby, the relevant results of the analysis are stored, i.e. irrelevant information has been filtered out before it is stored. For example, the results of the analysis are stored in an XML structure. Hereby, the result of the analysis, i.e. the structure representing the documentary material, is present in an electronic form and is thus a stored item occupying a minimized amount of storage space and it is also accessible for further electronic analyses.

In the method in accordance with the invention, the stored structure is formed in a hierarchical manner with the help of the generic objects based upon the elementary structural units. The operations on or with the elementary structural units and the generic objects are combinable in an arbitrary manner. The system can be designed in a flexible manner by the provision of a script data base 42.

Due to the determination of the contour of objects such as text blocks that are combined into zones, the results can be presented to a user in an optimal manner.

Provision may be made as is indicated in FIG. 6(a) for example, for a rectangle that encloses the contained objects to be placed around a zone (a text block in the example shown).

As is indicated in FIG. 6(b), it is also possible to place a rectangular block around the object whereby lines are specified in the zone and the rectangular coordinates of the objects and in particular of the words within the line are evaluated. The line is enclosed by a rectangle. The contour of this rectangle is matched to the contours of the rectangle for the neighbouring line. A stair-like rectangular block contour therefore arises if the lines are of different lengths. Provision may be made here for an edge smoothing process to be carried out during the contour determining process so as to eliminate small steps.

It is also possible to place a convex envelope around the zone as is indicated in FIG. 6(c). In the case of a convex envelope, the zone is enclosed by straight lines, whereby the angle between neighbouring lines may change in only one direction.

In the case of the rolling contour which is indicated in FIG. 6(d) and which is also referred to as an alpha contour, an electronic marker of a certain size “rolls” over the zone. Hereby, the corresponding “rolling lines” are straight lines which are of course determined by the size of the marker. The alpha contour ensures closeness to the objects, i.e. the surface area within the contour is minimized.

The method in accordance with the invention was described above for the case where the template is a printed document. The elementary structural units are then image pixels; items of data relating to the template are produced by a scanning process, said items being essentially items of pixel data which are arranged in a certain order in correspondence with the template.

If the template is already present in an electronic format as is the case for a web page for example, then the elementary structural units can be set at a higher level than the pixel level, at least outside image files. The template exhibits a certain optical structure which is reflected in the data structure of the template. The document is then printed in a “virtual” manner by the virtual printer driver 14: items of data relating to the documentary material are produced which optically portray the documentary material as a kind of printed image, whereby the data is present in a format that is processable by the device in accordance with the invention. The “virtual” print-out produced by the virtual printer driver 14 has the advantage that the electronic structure of the document itself does not have to be analysed, i.e. the document does not have to be converted, but only the optical structure is represented.

Provision may be made thereby for additional pixel data to be generated in order to enable them to be displayed to a user for example.

The items of data relating to the template that are produced by the virtual printer driver 14 are then broken down into elementary structural units which are determined optically.

Text elements such as letters or even whole words can be determined optically and hence are contained as such in the data relating to the documentary material which is supplied by the virtual printer driver 14. These text elements can then serve as elementary structural units in order to portray the structure of the original document in a hierarchical manner on the basis thereof. Thus, insofar as such text elements are concerned, the level of the elementary structural units lies above the pixel level. The portrayal of the structure can then be carried out more rapidly since less computation is necessary as one is now of course at a higher level.

1. A method for the structural analysis of a document, comprising:
breaking down a template of the document into elementary structural units; and
based upon these elementary structural units, producing generic objects to which one or more properties are assigned, wherein a structure representing the template is produced in an electronic format by means of the generic objects.

2. A method in accordance with claim 1, wherein the optical structure of the template is analysed.

3. A method in accordance with claim 1, wherein an analysis of the contents is performed.

4. A method in accordance with claim 1, wherein one or more properties are assigned to the elementary structural units.

5. A method in accordance with claim 1, wherein an assigned property is determined by at least one of the arrangement, the meaning and the hierarchy in the optical appearance of the template.

6. A method in accordance with claim 1, wherein the property or properties which are assigned to a generic object are definable.

7. A method in accordance with claim 6, wherein the number of the assigned properties is definable.

8. A method in accordance with claim 6, wherein the type of an assigned property is definable.

9. A method in accordance with claim 1, wherein arbitrary additional properties can be assigned to a generic object or to an elementary structural unit.

10. A method in accordance with claim 1, wherein a property assigned to a generic object comprises a type component for the type of property and a value component for the value of the property.

11. A method in accordance with claim 1, wherein a logical functionality is assigned to a generic object.

12. A method in accordance with claim 11, wherein the logical functionality is determined by the font size of text elements and the position of the text elements which are comprised by the generic object.

13. A method in accordance with claim 1, wherein operations are carried out on or with at least one of elementary structural units and generic objects.

14. A method in accordance with claim 13, wherein one or more of the operations selection, attribution, grouping, dividing, sorting, hierarchical formation or contour determination is carried out on or with at least one of the elementary structural units and the generic objects.

15. A method in accordance with claim 1, wherein the structure representing the template is produced in a hierarchical manner on the basis of the elementary structural units.

16. A method in accordance with claim 15, wherein hierarchically higher ranking objects are produced from hierarchically lower ranking objects by one or more of the operations selection, attribution, grouping, dividing, sorting, hierarchical formation or contour determination.

17. A method in accordance with claim 13, wherein operations concerning at least one of the elementary structural units and the generic objects are carried out by means of sub steps defined by a script.

18. A method in accordance with claim 17, wherein the script is stored in one or more script data bases.

19. A method in accordance with claim 17, wherein a script is subdivided into classes.

20. A method in accordance with claim 17, wherein a parameter dependent script is provided.

21. A method in accordance with claim 1, wherein there is provided a generic object of the type “collection” which can accommodate other objects.

22. A method in accordance with claim 1, wherein there is provided a generic object of the type “container” which contains objects of the same category.

23. A method in accordance with claim 1, wherein there is provided a generic object of the type “memory” which receives data and makes data available.

24. A method in accordance with claim 1, wherein there is provided a generic object of the type “document” which specifies a template.

25. A method in accordance with claim 1, wherein there is provided a generic object of the type “page” which characterises a page of the template.

26. A method in accordance with claim 1, wherein there is provided a generic object of the type “picture segment” which is concerned with related sequences of pixels within an illustrated page.

27. A method in accordance with claim 1, wherein the template is a printed template.

28. A method in accordance with claim 27, wherein the elementary structural units are pixel data.

29. A method in accordance with claim 1, wherein the documentary material is based on an electronic document and template data are produced by a virtual printer driver.

30. A method in accordance with claim 29, wherein the virtual printer driver produces template data relating to the template on the basis of the optical structure of the template.

31. A method in accordance with claim 29, wherein the elementary structural units of the template data relating to the template that are produced by means of a virtual printer driver lie at least partly above a pixel level.

32. A method in accordance with claim 1, wherein a contour determination process is carried out for an object.

33. A method in accordance with claim 32, wherein a contour in the form of a rectangle is placed around the object.

34. A method in accordance with claim 32, wherein a contour in the form of a rectangular block is placed around the object.

35. A method in accordance with claim 32, wherein a contour in the form of a convex envelope is placed around the object.

36. A method in accordance with claim 32, wherein a rolling contour is placed around the object.

37. A method in accordance with claim 1, wherein, following a process of scanning a template, black/white images are converted into grey images.

38. A method in accordance with claim 37, wherein, for the purposes of determining the foreground and the background, grey images with the same or a similar grey tonal value are compared.

39. A device for the automatic structural analysis of documents, comprising:
a breaking down device for breaking down a template of the document into elementary structural units; and
a structure producing device for producing a structure representing the template in an electronic format;
wherein the structure producing device comprises a device for producing generic objects to which one or more properties are or will be assigned, and for carrying out operations on or with at least one of the generic objects and the elementary structural units.

40. A device in accordance with claim 39, wherein the production of at least one of the generic objects and the operations upon or with at least one of the generic objects and the elementary structural units is based on optical criteria.

41. A device in accordance with claim 39, wherein there is provided a script data base for operations with or on at least one of generic objects and elementary structural units.

42. A device in accordance with claim 39, wherein a virtual printer driver is provided for producing template data based on a template which is in an electronic format.

43. A computer program product including at least one computer-readable medium and a computer program that is stored on the at least one computer-readable medium and comprises program code means which are suitable for implementing the method in accordance with claim 1 when running the computer program on one or more computers.

44. A computer program comprising program code means which are suitable for implementing the method in accordance with claim 1 when running the computer program on one or more computers.
